(19) United States
(12) Patent Application Publication
(10) Pub. No.: US 2009/0160193 A1
(43) Pub. Date: Jun. 25, 2009

(54) BENKATINA HYDROELECTRIC TURBINE

(76) Inventor: Daniel FARB, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/342,084

(22) Filed: Dec. 23, 2008

Related U.S. Application Data
(63) Continuation of application No. PCT/IL2007/000770, filed on Jun. 25, 2007.
(60) Provisional application No. 60/805,875, filed on Jun. 27, 2006.
(60) Provisional application No. 60/823,256, filed on Aug. 23, 2006.
(60) Provisional application No. 60/826,927, filed on Sep. 26, 2006.
(60) Provisional application No. 60/864,792, filed on Nov. 8, 2006.
(60) Provisional application No. 60/908,693, filed on Mar. 29, 2007.

(51) Int. Cl. F03B 13/00; F01D 1/30; F01D 25/24; F01D 5/14; B23P 15/00; F01D 17/00; F01D 15/10

(52) U.S. Cl. 290/54; 415/60; 415/182.1; 416/223 R; 29/889.7; 415/151

(57) ABSTRACT

New hydroelectric turbine devices, systems, and methods, based on recirculation of fluid through at least one turbine, offer the potential for less costly and greater energy output in many applications.

### FIELD AND BACKGROUND OF THE INVENTION

The present invention relates to a new hydroelectric turbine design that we call a Benkatina Turbine™ and, more particularly, to a hydroelectric turbine with any of a number of characteristics, most particularly designs in which the fluid is recirculated as it passes through the turbine. (The term Benkatina is used in honor of a mechanic of the ancient world named Ben Katin.)

Prior art includes numerous hydroelectric turbines of various designs. None have been found to have the devices described in the current invention.

Most of the hydroelectric turbines available succeed in extracting a small percentage of the energy passing through them. This is due to inefficiencies in any turbine. It is also due to the Betz equation, which limits the amount of energy absorbed by any one turbine as around 59%. The Betz equation assumes an open turbine without recirculation of the fluid containing the energy. One innovation of the current invention is the use of recirculation of the fluid in order to obtain more energy from a fluid flow on each pass of the fluid through the system. Therefore, the Benkatina Turbine is likely to obtain more energy from a smaller turbine area, particularly if several Benkatina Turbines are present in an array. It is intended to be small, scalable, and work particularly well in conditions where excess power is available, such as downhill piping and instream uses. It also enables greater control of water pressure for water engineers. It is particularly useful for conditions where installation costs are high, as in underwater currents, because it can obtain more energy per installation.

It has another advantage over horizontal blade turbines: H does not cause such a large disturbance in the downstream flow. Therefore, the Benkatina turbines can be grouped together more tightly.

Due to being scalable to many sizes, it can have the following applications, among others:

Instream hydroelectric

Dammed hydroelectric

Tidal/ocean currents

Vertical axis wind

Gutter and drain run-off

Piping

Hydroelectric storage

Battery recharging

There is thus a widely recognized need for, and it would be highly advantageous to have, a hydroelectric turbine design that accomplishes more in a smaller space and at a lower cost.

### BRIEF DESCRIPTION OF THE DRAWINGS

The invention is herein described, by way of example only, with reference to the accompanying drawings, wherein:

FIG. 1 is a diagram of a stright-line Benkatina turbine.

FIG. 2 is a 360-degree Blenkatina turbine in a superior view.

FIG. 3 is a diagram of different combinations of individual Benkatina turbines.

FIG. 4 is a diagram of an instream arrangement of a Benkatina system.

FIG. 5 is a diagram of a possible topography of Benkatina paddles.

FIG. 6 is a diagram of ways of making the Benkatina paddles.

FIG. 7 is a diagram of the Benkatina turbine used in conjunction with a piston or a plunger.

FIG. 8 is a diagram of the Benkatina turbine used in conjunction with a piston or a plunger in a condition of outflow.

FIG. 9 is a diagram of the Benkatina turbine used in conjunction with a piston or a plunger in a condition of return flow.

FIG. 10 is a diagram of inlets and outlets from a circular Benkatina system.

FIG. 11 is a diagram of a stacked Benkatina system.

FIG. 12 is a diagram of a hydroelectric storage system.

FIG. 13 is a diagram of a hydroelectric system attached to a building gutter.

FIG. 14 is a diagram of a hydroelectric system attached to a street gutter.

FIG. 15 is an engineering diagram of a Benkatina turbine.

FIG. 16 is a diagram of a Benkatina turbine in another configuration of diversions around a center.

FIG. 17 is a diagram of two Benkatina turbines along an omega shaped piping diversion.

FIG. 18 is a diagram of flow diversion.

FIG. 19 is a diagram of hydroelectric storage with a movable inlet/outlet.

FIG. 20 is a diagram of blade profiles.

FIG. 21 is a photo of a built model.

FIG. 22 is a close-up of a movable inlet/outlet.

FIG. 23 is a diagram of turbine vane designs.

### DESCRIPTION OF THE PREFERRED EMBODIMENTS

The present invention is of a hydroelectric turbine which can be used to increase the amount of energy obtained from a large number of flow situations and exert greater control over the production of electricity. Definitions: Fluid or flow can refer to any liquid or gas. In this discussion, we may refer to water, as the most common example of a fluid, but gas is also treated as a fluid scientifically, and all references to fluid include any type of fluid flow including gas unless otherwise specified. “Benkatina turbine” can sometimes refer to an individual turbine with the characteristic of recirculation of the fluid flow and to a system of at least two turbines. Paddles are considered to be a kind of “blade” but they are considered to have a rotational axis in the y-axis in relation to the x-axis of flow. A propeller blade has a rotational axis in the x-axis of the flow. Paddle wheels consist of several paddles. Each is paddle has a rotational axis not in the x-axis of flow, but usually perpendicular to it. A “Benkatina pipe” is a main chamber/side chamber arrangement that can contain a Benkatina turbine. Recirculation means that some of the fluid that has passed through a turbine is routed to a point from which it reenters the turbine.

The principles and operation of a Benkatina hydroelectric turbine according to the present invention may be better understood with reference to the drawings and the accompanying description.

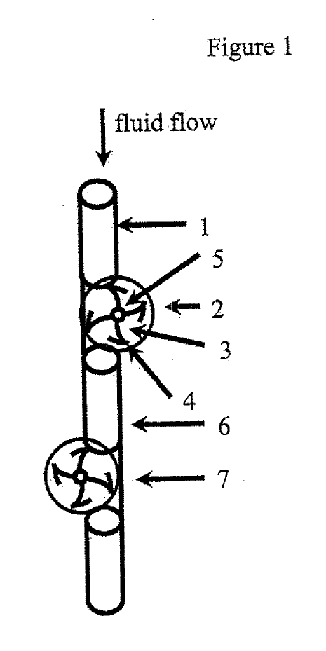

Referring now to the drawings, FIG. 1 illustrates a substantialy straight-line Benkatina turbine. FIG. 1 illustrates one of the basic points of the current invention: a main chamber (1) and a side chamber (2) where at least a part of the fluid flow (3) can make a circuit before being returned to the main chamber (6). Some of that flow hits one paddle and proceeds straight while some is diverted into the adjacent circular side chamber. Flow through a pipe or other means (1) turns at least one paddle (4) in the pipe pathway. Part (5) is the hub of the paddles. It is connected to a generator. Ideally, the main and side chambers are of the same diameter throughout. (The diameter as referred to here is the distance from the hub to the outside of the side chamber; that would be the radius of the turbine. In general, the side chamber is twice as wide as the main chamber.) The side chamber could also be of lesser or greater diameter than the pipe in other embodiments. One of the other unique points of the patent is placement of two turbines, ideally Benkatina types, in proximity to each other within the same system, as in parts (2) and (7). Ideally, the proximity is within 3 diameter lengths of the turbines, but it can be more or less. This enables greater control of the amount of energy removed from the flow within a small area. The two Benkatina turbines, as shown here (2, 7), are on different sides of the main chamber; they may be on any side of the main chamber from each other. The paddle (4) ideally nearly fills the interior of the side chamber. Part (1) shows the main chamber. It can be part of a longer section of pipe of the same diameter, or connected to an inflow pipe of a different diameter. The ideal is that the passageways within the Benkatina section itself are equivalent in size.

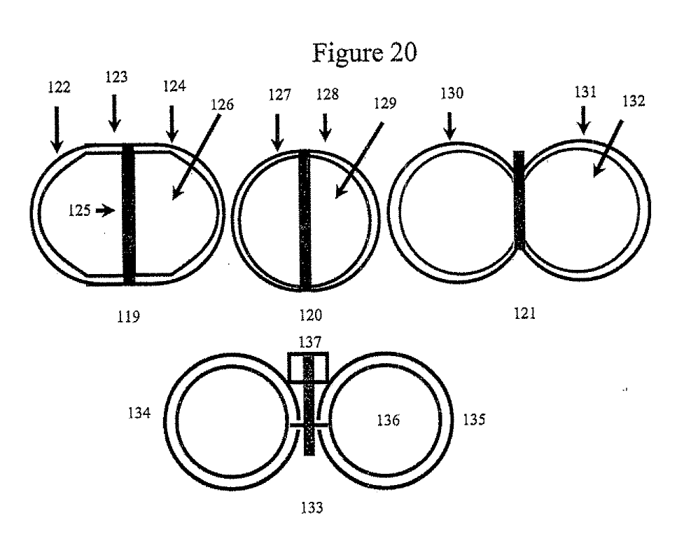

The turbine has an axis at the interface of the main and side chambers. This interface location is defined as being in the imaginary point where the wall of the main chamber would have continued had a side chamber not been formed, and in the middle of the gap along the width of the opening between the main and side chamber. This could assume several positions, as FIG. 20 will show.

The exterior of the main and side chambers can be solid, or solid frame with lighter material attached.

Note that FIG. 1 shows the imaginary continuation of the outline of the side chamber within the main chamber; in reality, it does not block the main chamber.

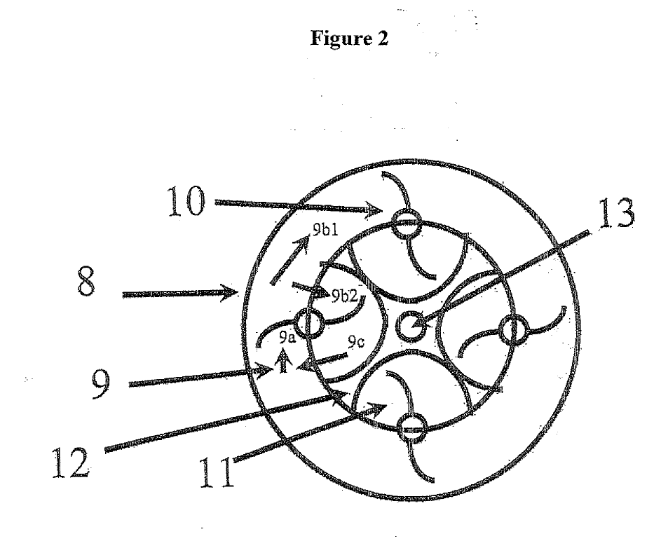

FIG. 2 is a 360-degree Benkatina turbine (8). As shown before, it has side chambers (11) adjacent to the main flow chamber (9). The fluid in the main flow chamber (9a) proceeds forward into (9b1) or recirculates in path (9b2), from which the makes a turn (9c), and reenters the main flow chamber (9), where it takes path (9a). Clearly, this will happen most efficiently if the area is entirely saturated with fluid. Each internal circular path has at least one paddle rotating around a hub (10), which is ideally located at the middle of the main and side chambers. Each hub is connected to a shaft and a generator for the production of electricity. Ideally, there are four Benkatinas within the larger circular Benkatina. The central shape is ideally hollow in areas (12) between the side chambers and the center. In one embodiment, a central generator (13) also is capable of movement and electricity generation from the torque on the external paddles of the side chambers. This may lead to greater utilization of the energy in the fluid flow.

Another variant of the Benkatina is round in the shape shown in FIG. 2, but the outer and inner chambers are not circular, but rather some other shape, such as cylindrical. In that case, the height of the whole turbine displayed in FIG. 2 would be greater than the width. This is not visible from the picture, which is a superior view. A Benakatina turbine of the type shown in FIG. 2 with a greater height than width could be used in certain applications, such as rivers, so that a larger volume can pass through the turbines in a shape that is higher than it is wide. The inlets and outlets should be arranged accordingly. Some arrangements will be shown later. Ideally, both vertical and horizontal diameters will remain the same within the Benkatina Turbine.

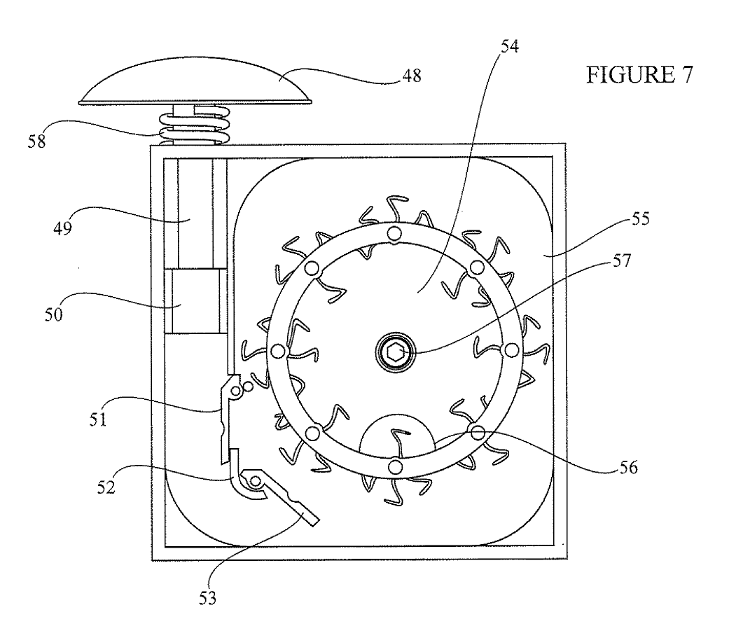

One novelty of the Benkatina turbine system variation shown in FIG. 2 is the capture of energy in at least two rotational axes simultaneously by the translation of power from the outer turbines to the inner one (when the inner hub rotates). An additional optional but important feature is the nearly 360 degree passage through the system. This enables at minimum the improved capture of energy from pressures that are great compared to the size of the turbine, as when a person is applying pressure to a relatively small object as in FIG. 7, but it is also possible that the Benkatina turbine is slightly more efficient than others because its nearly 360 degree flow through the rotational axes absorbs a higher percentage of thermodynamic energy by means of a reduction in turbulent flow and by capturing the energy otherwise spent on torquing paddles connected to the center of a turbine. Because of this unique design, it is possible that a Benkatina turbine in a substantially horizontal orientation can improve the process of obtaining hydroelectric energy from dams and other bodies of water. It can also be used with flows of gas.

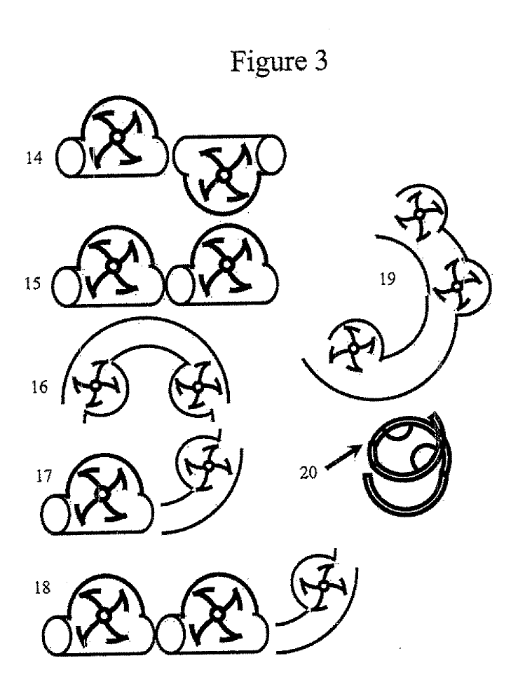

FIG. 3 is a diagram of different combinations of individual Benkatina turbines. (14) is a straight line arrangement of two individual turbines on a different side of the main chamber. (15) is a straight line arrangement of two individual turbines on the same side. (16) shows a curved main chamber with two individual turbines on the inside. The theoretical advantage of this arrangement is that, where the blades are designed appropriately, it takes greater advantage of the faster flow on the outside of the curved main chamber. (17) and (18) show combinations of straight and curved Benkatinas. (19) shows arrangements of fenkatinas around a curve in a pipe. The individual turbines can be on different sides of the main chamber. The individual turbines can be on the same side of the main chamber. (20) shows a main chamber in the shape of a corkscrew. As the elevation of the main chamber changes and winds down, at least one turbine can be placed off the main chamber.

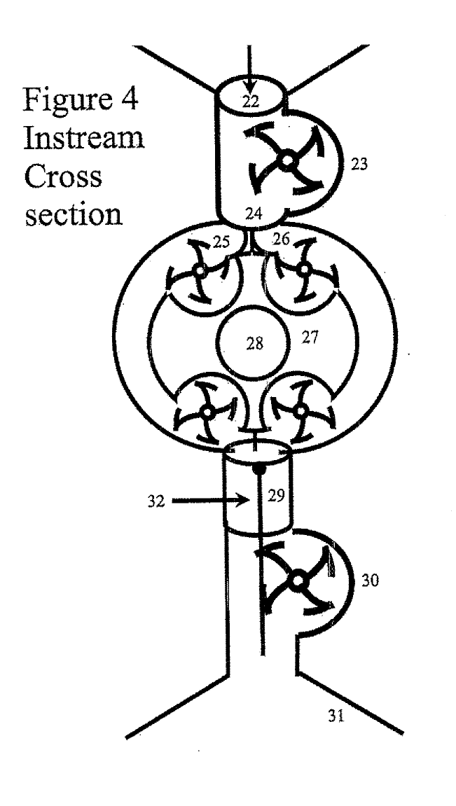

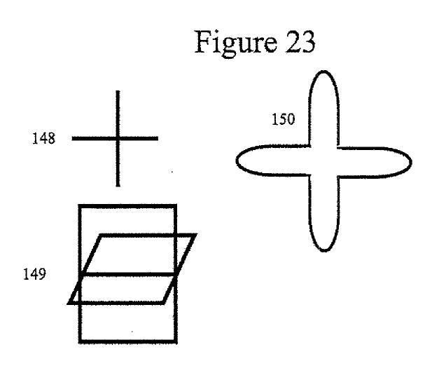

FIG. 4 is a diagram of an instream arrangement of a Benkatina system. This and similar arrangements could be used for river and ocean current flows. The flow enters from the top through initial main chamber (22). There is an optional collector (21) attached to the intake. In one embodiment, the initial main chamber has a Benkatina turbine (23) followed by a continuation of the initial main chamber (24). The flow now divides into secondary smaller main chambers (25) and (26). Along these chambers can be at least one Benkatina turbine, In the ideal configuration, the secondary smaller main chambers rejoin to form a final main chamber (29), which may also have at least one attached Benkatina turbine (30) in one configuration. The outlet may have an optional diffuser (31). This system may be used for tidal currents and may be fixed in place, and use two-way paddles or two-way generators. In the ideal configuration, part (28) is the supporting structure or tower for the turbine system. (27) is the hollow area on the inside of the system. (28) may be rigidly attached to the system, or free to allow rotation. In the case of rotation around a central axis being permitted, the optimal angling of the turbine system may occur either through electronic control and sensors, or by means of a tail and vane (32). The vane may be attached in a number of places on the system. If the size of area (27) is sufficient, the turbine may also adapt vertically to changes in current flow using a vane as described later in FIG. 23.

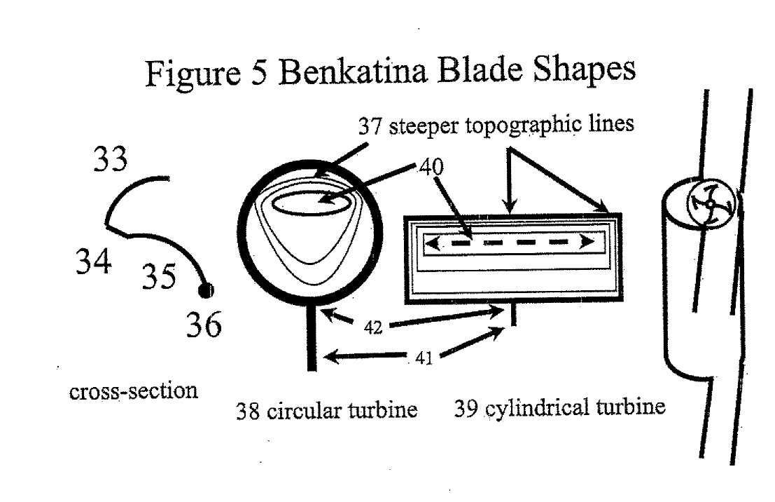

FIG. 5 is a diagram of a possible topography of Benkatina blades. Many shapes can be used. Ideally, whatever shape is used will have some of the characteristics shown in this figure. This figure illustrates the concept of pushing the flow and the torque into the periphery of the blade—or, in its ideal embodiment, paddle. The arrangement shown can be used with other types of turbines.

The shape of the blades is important in order to maintain maximal flow. FIG. 5 shows that a cross-sectional arrangement of points (33), (34), and (35) is ideal for enhancing the natural tendency of the flow to the outside of the blades in a circular environment. Pushing the flow in that direction increases the torque and the energy captured. Part (35) is the shape attached to the central rotation point (36), which drives a shaft and a generator. Point (34) is a substantially straight area, ideally at 90 degrees from the edge of part (33). The outer edge of part (33) is congruent and close to the outside wall of the chambers. Part (34) can be left out and part (35) could continue in its arcuate shape till it meets part (33). Part (35) is ideally convex to the direction of flow. Of course, other shapes can be used with the turbine, but the shapes just described offer a theoretical advantage.

The topography of the blades also forces the flow to the periphery, in the ideal embodiment. The picture shows examples of topographic lines, with the outer edge being the steepest, in both circular (38) and cylindrical (39) paddles. In general, the periphery has a steeper topography (37) and the deepest part is in the peripheral half (40). In the circular turbine (38), that steeper edge ideally consists of no more than the outer half of the paddle blades. In a cylindrical turbine (39), the shape of the paddle blades is ideally rectangular along the outline, with the steepest portion towards the periphery of the blades, and ideally no more than halfway towards the inner portion on the sides. In the circular turbine, the topographies are ideally parabolic in outline.

(41) attaches the paddle to the central hub. (42) is the medial part of the paddle. As shown, this is for a pipe and turbine that are cylindrical shaped in order to accommodate a situation when a cylindrical configuration is more appropriate, such as certain instream situations.

In summary, the ideal Benkatina paddles in cross-section consist of two arcs at a minimum; the outer arc (33) is parallel to outer circle of the circular chamber in all its periphery and nearly at the edge of the chamber. The other arc (35) is convex to the flow, and connects from the edge of the outer arc to the center point, in some cases with a radially oriented portion (34) in between. In a cylindrical turbine with a rectangular outline to the paddle, there are 3 sides (the periphery and two sides) with a steep topography in the peripheral half of the paddle.

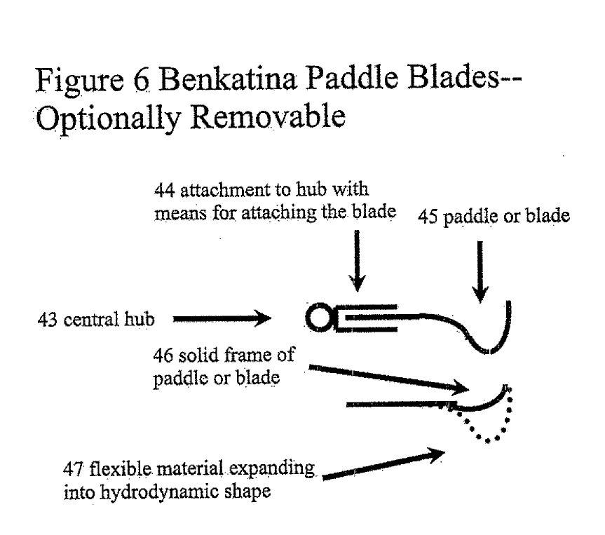

FIG. 6 is a diagram of ways of making the Benkatina paddles. In one embodiment, the paddles are removable. This can be an aid for maintenance. (43) is a central hub, attached to a shaft and generator. (44) is a piece attached to that in a radial orientation that contains means for attaching the paddle (45). An alternative system for the paddles can comprise a solid frame (46) with a flexible interior (47). That flexible interior can be taut or not taut. If that flexible interior is not taut, then it can assume a hydrodynamic shape from the pressure of the flow. In one embodiment, it can do so in each direction. This would have the advantage of making a lighter paddle, which might have the disadvantage of being less durable. A method for easy replaceability could solve the problem.

FIG. 7 is a diagram of the Benkatina turbine used in conjunction with a piston or a plunger. FIGS. 7, 8, and 9, use a picture with a plunger apparatus, but any kind of piston device is equivalent. (48) is a plunger, or other device to generate linear movement of fluid or pressure. In other embodiments of the Benkatina Turbine, the external pressure can come from other sources, such as a stream of water, a piston, or a compressor. An optional spring (58) helps the plunger return to position for another application of pressure. Part (49) is an enclosed area for a piston (50). A fluid (51) is present on the inside. The piston presses against that fluid. The basically linear force of the piston pushes the fluid through a one-way valve (53). The fluid then returns through a separate one-way valve (52) after passing through an array of small turbines contiguous to the fluid interior (55). The small Benkatina turbines are located at the periphery of a ring or cylinder with their hubs on the outside of the ring. These small Benkatina turbines may have a side chamber (56) in their ideal embodiment, or may move through an unenclosed environment (54). In the case of an unenclosed environment, the interior fluid (54) could be lighter than the exterior (55), and attracted to a hydrophobic or hydrophilic surface attached to the interior of the ring. In another embodiment, the central hub may also rotate and turn a shaft and generator. The contents are a liquid, in different embodiments water or hydrophilic, oil or hydrophobic, or both.

The smaller wheels are located in openings of the larger wheel at the periphery, that is, sandwiched between the outer flat edges. The edges of the main channel for fluid flow is (55) are ideally curved. Ideally, the inflow (53) and outflow (52) are designed so that the flow makes nearly a 360 degree circuit around the energy capture device. In FIG. 7, it is possible for the water to continue circulating beyond 360 degrees. In various embodiments, the central cylinder is solid or, ideally, hollow and contains no fluid, so that the friction is reduced, and it connects to the outer wheel through radial connections. So the basic shape of the whole device is a flattened cylinder. The outside of the cylinder can have a solid, planar connection to the center on the base and apex of the cylinder, or it can be connected through radial spokes, like an old wagon wheel of a carriage, to the base and apex of an outside hollow cylinder. In either case, the size of the blades of the outer turbines are ideally similar to the size of the outer chamber, so that virtually all flow contacts the outer paddles. Tiny generators connect to each turbine's axis of rotation, including, optionally, the center of the cylinder.

The position of the one-way valves increases the pull on the circulating fluid in the desired direction. Circulation is maintained in the same direction in FIG. 7 by the two levers or valves located below the piston. Any other one-way valve can be used in place of these levers. When the push-down occurs, the lower lever (53) opens and flow can go through. The upper lever (52) stays closed since flow forces it to stay as is. When the pressure from the knob is released, the spring (58) forces the piston or plunger (50) upwards. At that time, flow circulation is maintained and suction occurs under the piston. Such suction causes the opening of lever (52) and closing of lever (53).

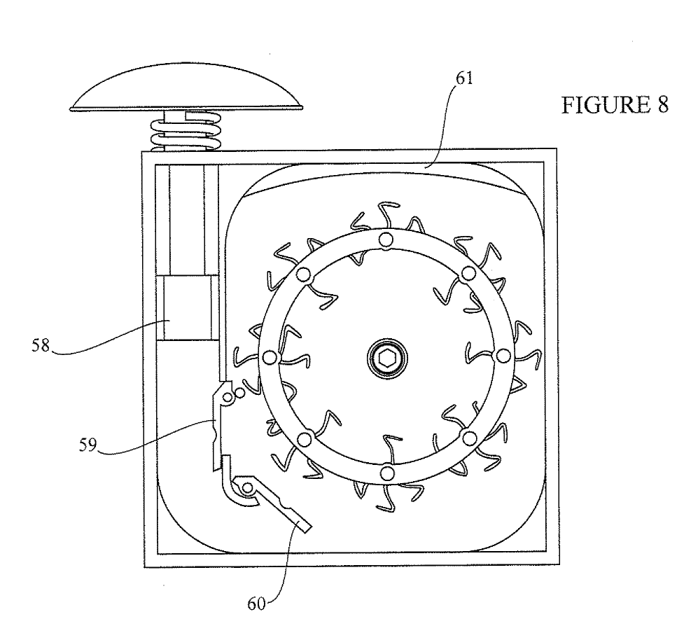

FIG. 8 is a diagram of the Benkatina turbine used in conjunction with a piston or a plunger in a condition of inflow.

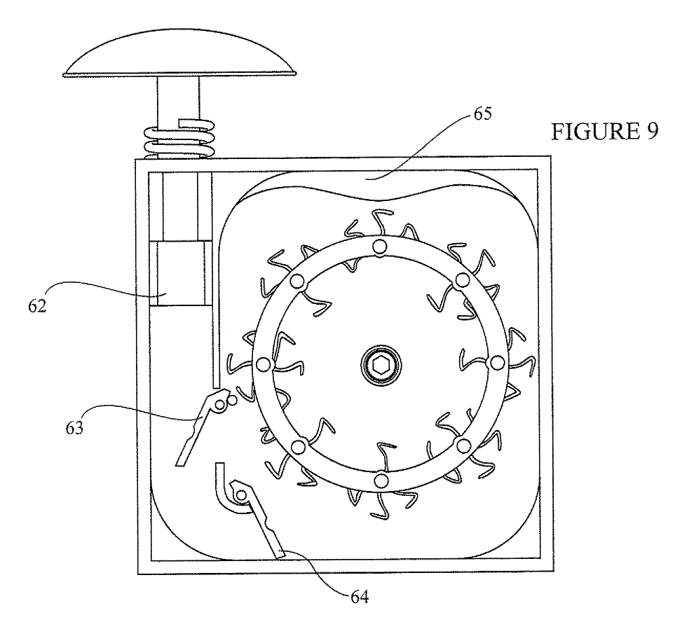

FIG. 9 is a diagram of the Benkatina turbine used in conjunction with a piston or a plunger in a condition of outflow from the turbine or return flow to the piston area.

FIGS. 8 and 9 show the concept with an air membrane that moves when the plunger is pushed in and pulled back. In FIG. 8, the plunger is pushed down. That pushes down the piston (58) and forces open the lower lever (60) while closing the upper lever (59). The flexible membrane (61) expands. In FIG. 9, the plunger and the piston (62) move out. This movement causes the upper lever (63) to open and the lower lever (64) to close. The flexible membrane (65) moves inwards. The membrane is only one possible solution. Other means for adjusting the pressure changes are possible, such as an adjacent reservoir of fluid.

The mechanical device in the pressure plunger turbine as shown causes the fluid to run around the Benkatina Turbine. Fluid may be hydrophobic, hydrophilic, or both. As water and oil are not compressible liquids, there is a need to leave room for the pressure increase and decrease. For that purpose a membrane structure is one means to absorb the non-compressible liquid movement and allow the circulation. This membrane on the top of the box divides the liquid from the air and is flexible.

In FIG. 9, the membrane should only come inside far enough so that it does not contact the paddles. It is shown as very close in this figure to illustrate the movement of the membrane.

This membrane is not necessary for other uses of the Benkatina Turbine, such as hydroelectric.

Power Calculations

The power that comes out of the rotational movement of the Benkatina Turbine, in the miniature plunger shown in FIGS. 7-9, is a mixture of two kinds of rotations. The piston pressure exerts force on the small paddles by the fluid flow.

Assuming that:

The piston displacement is 50 mm

Starting from zero velocity

It takes 0.3 sec to move the piston down

The velocity (at the bottom) will be

V₁=V₀+a×t

when using for simplicity the formula

a=3 g=3*9.8=29.4 m/sec²

V₁+29.4×0.3=8.8 m/sec

This size of velocity generates mass flow accordingly.

m=ρ×V×A

If we take for room temperature ρ=997 kg/m³ for water

And

The area of the single paddle A=0.000225 m2

We get

Φ=997×8.8×0.00025=1.97 Kg/sec

The force acting will be

F=ρ×V²×A=1.1 N

and the power each wheel generates

P=V×F=9.7 Watt

For each push down, a wheel with 8 paddles can produce about 80 Watts.

While the force is exerted on each paddle, some of it goes to the large wheel (in the condition where part 57 also rotates) and rotates it in the same direction if it is not fixed. The rotation of large wheel is proportional to the outer liquid circulation.

The boundary layer which causes the drag force on the paddlewheels can be lowered by using less dense liquid inside the Benkatina Turbine. The quantities of each liquid used will be determined by the volume of fluid inside the outer circumference of the turbine, not including the outer channel. That will help to reduce friction while the paddles are turning.

The current invention is more effective than a wheel with stationary paddles alone because it maintains laminar flow and relatively stable boundary layers around the wheel, in addition to its capture of a greater amount of the flow energy.

When the configuration of FIGS. 7-9 is used as a battery recharger device, it may be enhanced for commercial use by making one side clear, using bright colors for the fluid and parts, and making it enjoyable for users to watch the moving parts. It could be used for many other piston applications on a larger scale. Because of the high density of water, it may help to reduce space used with other piston/compression arrangements.

In one embodiment, a series of hydrophilic and/or hydrophobic surfaces deliver an increase in efficiency by directing the denser fluid to the outside, so that the less dense fluid on the inside of the larger wheel decreases the resistance on the smaller wheels. Density may be further increased in the denser fluid by the use of solutes.

In embodiments of any of the devices and systems in contact with fluid or water in an energy capture system, hydrophilic and hydrophobic coatings may be used. This may aid in directing flow, protecting against corrosion, and increasing speed.

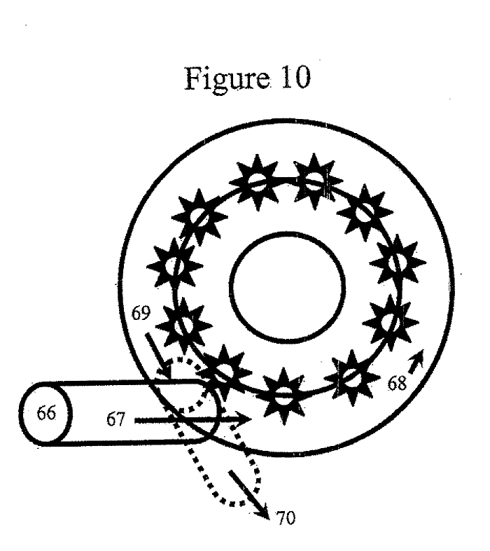

FIG. 10 shows the inflow and outflow into a substantially flat Benkatina turbine system and shows how the outflow can continue in any direction from the inflow. At least one one-way valve or means such as a wall at the end of the 360 degree circuit will limit interference by flow from the outflow tube. Such a one-way means may be located at the external inflow and outflow tube periphery rather than inside the turbine itself. It may be used to capture vertical energy from a dam, river, or other situation of falling water by having inlet and outlet tubes that are ideally angled at slightly greater than zero degrees above the horizontal as in FIG. 10, where tube (66) is intended to display the angle of the tube above the flat Benkatina system. The fluid then continues through points (67-70) and outward inferiorly.

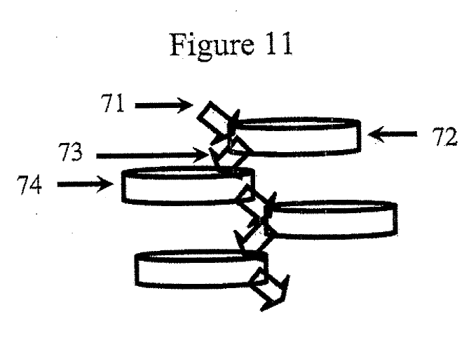

These systems can be used in a stack of connected turbines, the outflow from one descending to the inflow of the next, as in FIG. 11, where inlet (71) leads to turbine (72), to outlet (73), and into turbine (74). The gentle nature of the flow as compared to other methods of generation of hydroelectric power may result in a more efficient conversion of energy from the descent of the water.

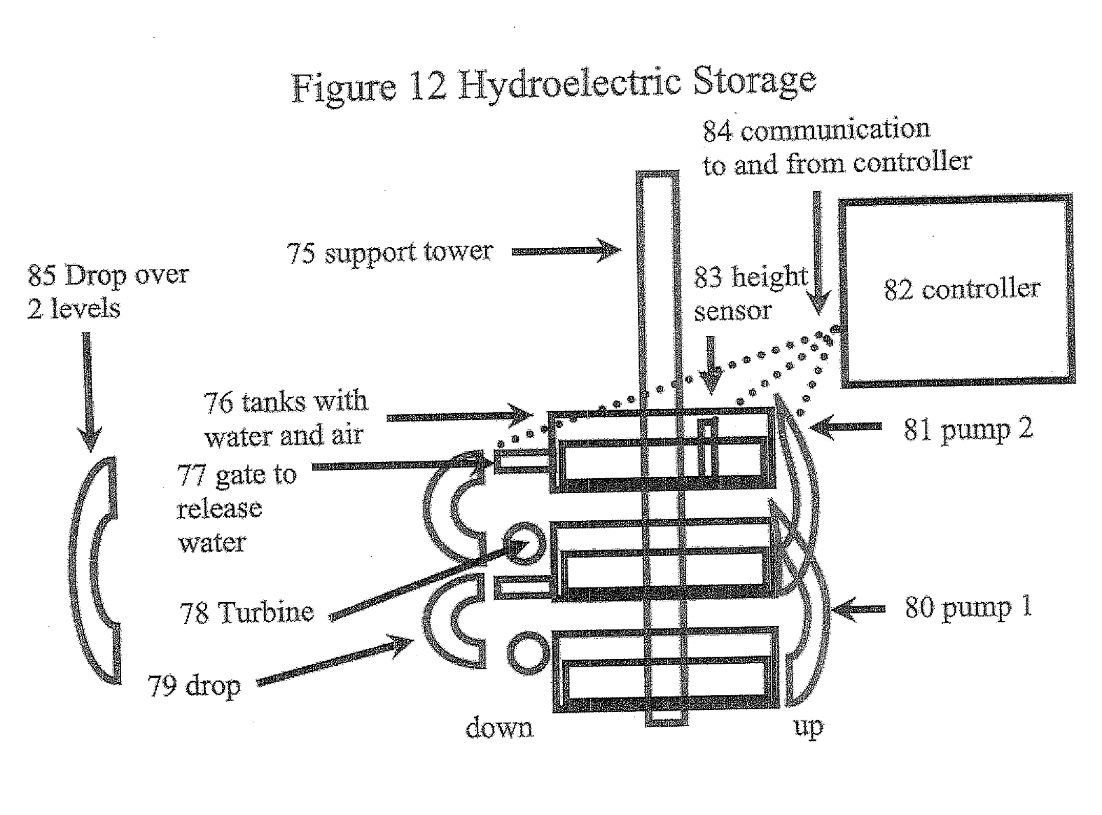

FIG. 12 is a diagram of a hydroelectric storage system. (75) is a support system or tower. (76) shows tanks with water and air, but it could be any liquid and gas. Each tank has an outlet (shown here on the left) and an inlet connected to a pump (shown here on the right as 80 and 81). The tanks may be connected in any of several fashions—directly to the one above, or to one several steps up, etc. Each outlet requires a gate (77) to release liquid through a rigid or non-rigid pipe (79, 85) through a turbine (78) into a lower tank. Many combinations of tanks, drops, and pumps can be used. Ideally the gates and pumps are under electronic controls (82) that obtain input (84) from sensors (83) of the height of the liquid and respond to inputs regarding the need for energy.

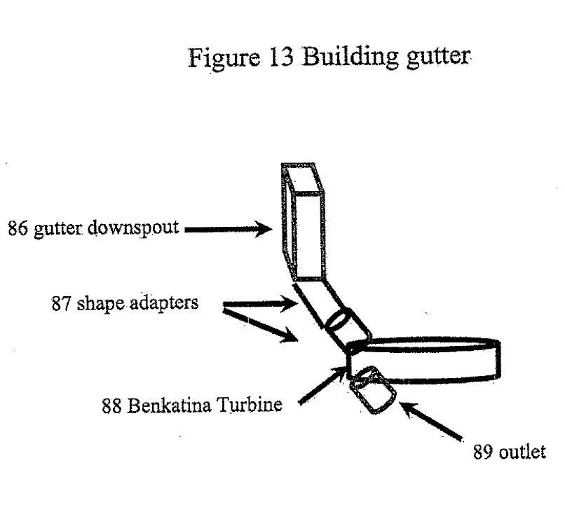

FIG. 13 is a diagram of a hydroelectric system attached to a building gutter, The attachment of a turbine to a building gutter is a new concept. The figure illustrates how a turbine, ideally a Benkatina Turbine, can be fitted to a downspout (86) of a house or commercial building. A connecting piece or pieces (87) are required to provide entry of the water into the turbine (88). In the ideal embodiment, a flexible tube surrounds the gutter outlet and converts the contents into circular flow (since many gutters are not circular in cross-section) by attaching to a rigid circular pipe at the other end. The circular pipe feeds into the turbine. In other embodiments, other kinds of pipe can be used. After turning nearly 360 degrees in the Benkatina Turbine, the water exits (89). Any of the other Benkatina variants can be used as appropriate.

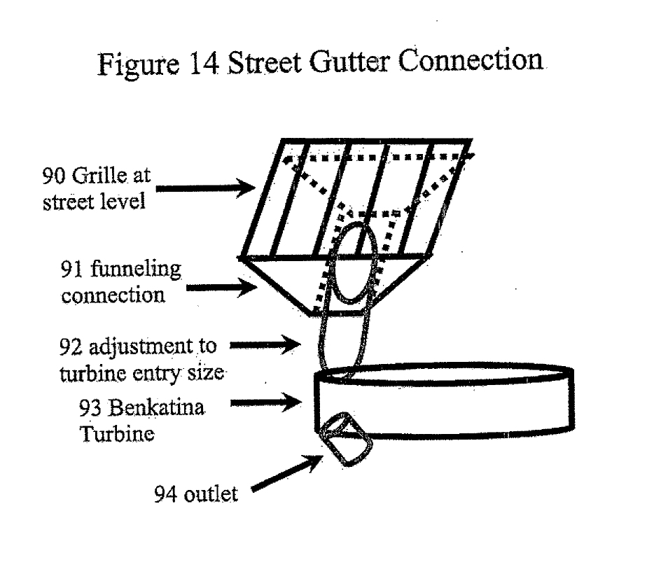

FIG. 14 is a diagram of a hydroelectric system attached to a street gutter. The attachment of a turbine to a street gutter is a new concept. The figure illustrates how a turbine, ideally a Benkatina Turbine, can be fitted to a street system. The grille (90) empties into a funneling connection (91) that adapts (92) to the shape of the turbine (93), which is ideally suspended from the grille or other structures on the street gutter, so that it is below the level of the street. (94) is the outlet from the turbine. Ideally, the funneling could be is shaped so it is somewhat parallel to the direction of typical inflow to the gutter so that velocity of the liquid is maintained.

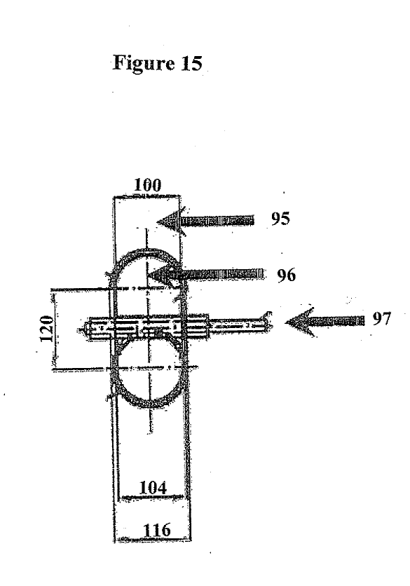

FIG. 15 is an engineering diagram of a Benkatina turbine. (95) is the main chamber. (96) is a side, cut-away view of the side chamber where it meets the main chamber. (97) is the shaft connected to the middle of the paddle wheel that transmits rotational motion to a generator.

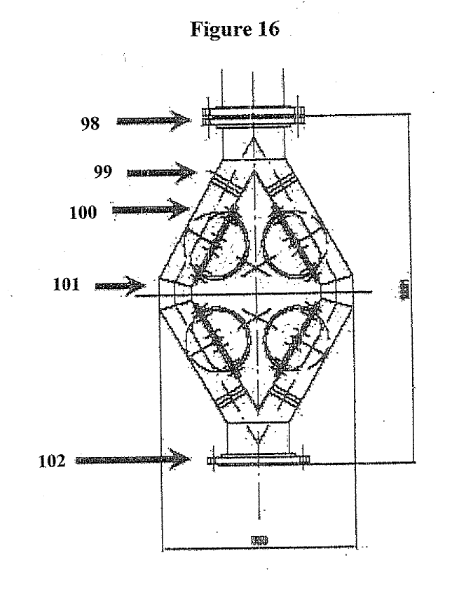

FIG. 16 is a diagram of a Benkatina turbine in another configuration of diversions around a center. This could be used for instream or for piping. (98) is either the entry pipe connection or the entrance of instream fluid. At point (99) the flow diverges into two streams, ideally each half the size of the original inlet. Each flow passes through at least one turbine (100). (101) is a piece of piping that changes the direction of the piping from outward to inward so that the two streams of flow can rejoin at areas (102) and exit or rejoin a piece of piping. An optional valve or blockage may be placed at point (99).

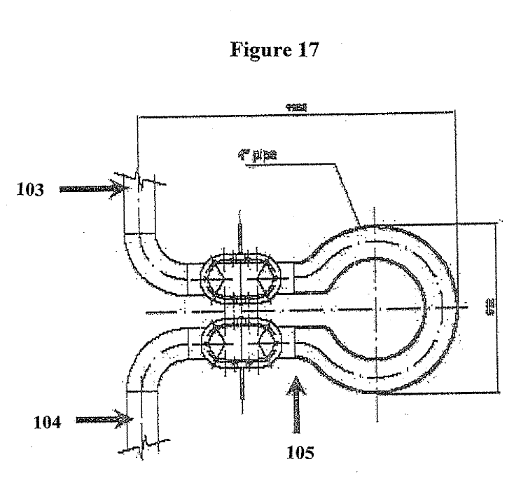

FIG. 17 is a diagram of two Benkatina turbines along an omega shaped piping diversion. (103) is the inlet and (104) the outlet. The omega shaped area (105) allows the addition of several turbines within a small distance from one part of the straight pipe (103) to the other (104).

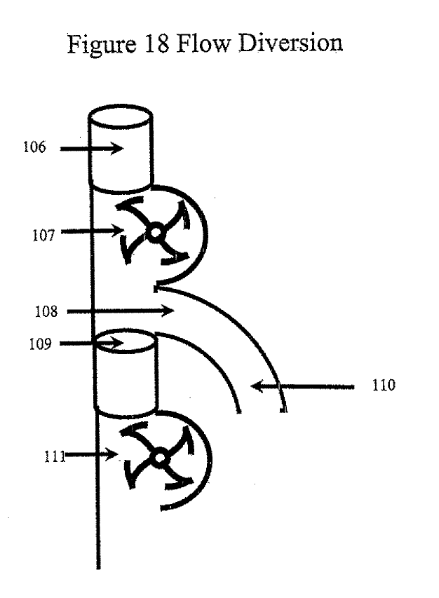

FIG. 18 is a diagram of flow diversion. This addresses the issue of allowing a lower cut-in speed by directing the fluid either through only one turbine and then the exterior or the continuation, or by directing the fluid through an additional turbine before continuing. Thus, this turbine system can handle a wider range of fluid speeds than currently available turbines. This is ideal for variable underwater currents. The fluid enters through chamber (106). It passes through turbine (107). Here it is shown as a Benkatina Turbine, but it could in other embodiments be any other turbine. The fluid then has a choice of paths, either through points (109) and (111) through a second turbine, or through point (108) and chamber (110) to exit or continue. If the flow is slow, it will not have the force to move through point (109) but will exit through (108). Particularly if the chambers are the same size, point (109) will act as dead space, and the flow can proceed through (108). If the flow has greater force, it will proceed through (109). What has been described is a way of accomplishing flow diversion and a wider range of cut-in speeds automatically, but other means would be more precise. Such means could include valves and passageways under electronic and mechanical control, or turbine components that engage and disengage. (108) and (109) would be likely points to place flow or pressure sensitive valves.

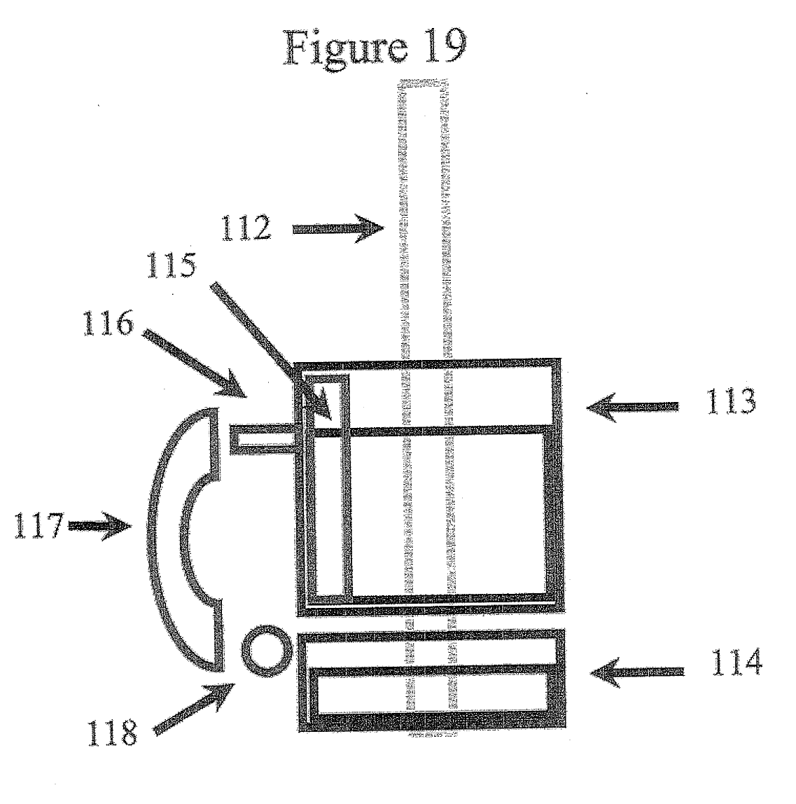

FIG. 19 is a diagram of hydroelectric storage with a movable inlet and, optionally, outlet. The idea here is that fluid can be discharged in small increments with the maximum head. (112) is the tower. (113) is the upper tank and (114) is the lower tank. (115) is a track for the outlet gate (116) to move in. (117) is a flexible hose that connects to a turbine in a lower tank or other receptacle (118). The outlet gate (116) is controlled to provide fluid from the upper section first. Not shown, for reasons of clarity, is the inlet into the upper tank from the lower tank. That inlet has a similar appearance, except that it has a pump to direct fluid upwards instead of a turbine, and that the inlet is above water level.

A movable inlet can work much the same way except to provide water, with a control that ensures that the inlet is always located with its lowest point just above the upper surface of the fluid. Said control can be a flotation device. The inlet follows a track such as part (115). A pump replaces the turbine at position (118), except that it is always position to take in from below the water level and move into the upper tank through position (116) above the water level.

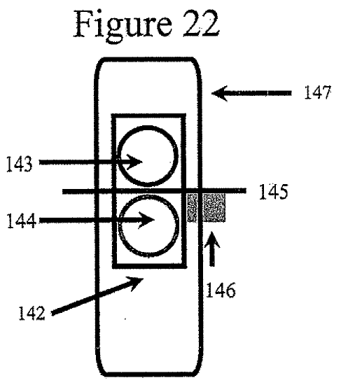

FIG. 22 is a close-up of a movable inlet/outlet. (147) is the guide or track. (142) is the piece holding the inlet (143) and outlet (144) together near the surface of the liquid (145), so that the inlet is just above the liquid surface and the outlet just below. The outlet will have a control valve at some point to prevent opening until outflow is needed. A floating means (146) is attached to part (142).

FIG. 20 is a diagram of blade profiles for a Benkatina turbine. According to the present invention, the central shaft and side chambers could contact the main chamber at a number of different locations (pictures 119, 120, and 121) but the ideal configuration is picture (133) because of its symmetry and maintenance of the same flow shape as the main chamber (135) within the side chamber (134). In addition, it allows for more compact placement of the shaft and generator (137). In the other pictures in this figure, (125) is the central shaft; (124, 128, and 131) are the main chambers; (123, 127, and 130) are the side chambers of different shapes, (126, 129, and 132) are the blades of different shapes; (123) is a small linear extension of the chambers in that particular design.

We define the side chamber as consisting of the passageways shown in FIG. 20, even if the side chamber assumes a tubular shape connected only by the rod to the blades, and not directly contacting other parts of the side chamber, as in picture (133).

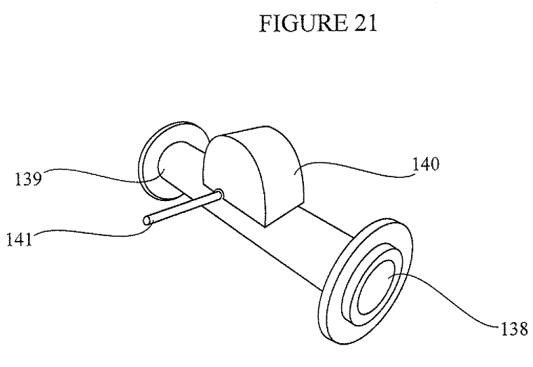

FIG. 21 is a photo of a built model of a 4 inch diameter pipe. (138) is the inlet or outlet. (139) is the main chamber. (140) is the side chamber. (141) is the shaft to be is connected to the generator.

FIG. 23 is a diagram of turbine vane designs. A vane with 4 sides at 90 degrees from each other will enable vertical tilting of a turbine in the direction of flow as well as the common horizontal tilting. This can apply to any turbine. Parts (148), a cross-section, and (149), a side view, illustrate this. Another type of vane (150) can be used with turbines like the Benkatina that enclose the fluid and can also perform the function of a diffuser at the same time. It can have at least two sides, preferably four, and simultaneously function to orient the turbine.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a turbine that works by partial recirculation of fluid and disclosing its applications. Numbers in parentheses refer to the figures.

It is now disclosed for the first time a pipe, called a Benkatina pipe, for a fluid,

comprising:

a. A main chamber (1),
b. A substantially semicircular, side chamber (2) in communication with the main chamber along the straight side of the side chamber. We define it as “substantially semicircular” because in the case of a curved main chamber, the side chamber will not be exactly semicircular on that side. The main chamber is the pipe.

According to another embodiment, the side chamber is only curved on the side of its circumference. (In other words, the side chamber need not be perfectly circular; it can even be flat on two sides and look like a partial disc.) According to another embodiment, the side chamber is curved on all three sides. (This is the ideal. The fourth side is its interface with the main chamber, which is open.) According to another embodiment, said side chamber's diameter at the center of the semicircle (5) is located along the imaginary continuation of two points of the wall of the main chamber. (119, 120, 121) According to another embodiment, said side chamber's diameter at the center of the semicircle (5) is located along the imaginary continuation of one point of the wall of the main chamber. (133) According to is another embodiment, said side chamber has a shape (cross-sectional) of no less than a semicircle on each side of its axis. (122, 127, 130, 134) According to another embodiment, said side chamber is a circle on each side of its axis (133). According to another embodiment, said side chamber has an axis (5) perpendicular to the direction of main chamber flow. According to another embodiment, said side chamber (2, 140) has a radius substantially equal to the diameter of the main chamber. (That applies to its vicinity. Of course, the pipe diameter can be different before it enters the area of the Benkatina Turbine. According to another embodiment, the main chamber has a continuation on the other side of its connection to the side chamber. (6) According to another embodiment, said main chamber in the area of the side chamber is curved. (16) According to another embodiment, said main chamber in the area of the side chamber is not curved. (14, 15) According to another embodiment, said main chamber in the area of the side chamber is curved in the direction of the side chamber. (16) According to another embodiment said main chamber in the area of the side chamber is curved but not in the direction of the side chamber. (19) In one embodiment, the system either comprises c. a second substantially semicircular side chamber, originating from the main chamber within 5 main chamber diameters of the end of the first side chamber. (7) In one embodiment, the system further comprises c. a second substantially semicircular side chamber, originating from the main chamber within 4 main chamber diameters of the end of the first side chamber. (7) In one embodiment, the system further comprises c; a second substantially semicircular side chamber, originating from the main chamber within 3 main chamber diameters of the end of the first side chamber. (7) In one embodiment, the system further comprises c. a second substantial semicircular side chamber, originating from the main chamber within 2 main chamber diameters of the end of the first side chamber. (7) In one embodiment, the system further comprises c. a second substantially semicircular side chamber, originating from the main chamber within 1 main chamber diameter of the end of the first side chamber. (7) According to another embodiment, the main and side chambers are cylindrical. (This is primarily for situations such as streams and dams, where a small surface area and a greater depth are useful.)

In one embodiment, the system further comprises a c. a collecting pipe (21) connected to the main chamber.

In one embodiment, the system further comprises a c. a diffusing pipe (31) connected to the main chamber.

It is now disclosed for the first time a Benkatina turbine, comprising:

a. a Benkatina pipe,
b. a turbine placed in said pipe at the intersection of the main and side chambers. (4, 5)
In one embodiment, the system further comprises c. a paddle wheel on the turbine with an axis perpendicular to the axis of flow.

According to another embodiment, said turbine's paddle wheel substantially fills both the main and side chambers of said pipe. (4) According to another embodiment, a turbine shaft (5) of said turbine is located at the interface of the main and side chamber, the radius of said shaft plus the remaining diameter of the main chamber being slightly less than the diameter of the main chamber. (It should basically fill the chamber.) According to another embodiment, the side chamber's axis is substantially vertical. (This is the ideal; this is more likely to ensure a full saturation of fluid in the turbine for optimal functioning. But the other claims do not exclude it being horizontal so that a gas can be partially present in the side chamber.) According to another embodiment, said turbine has an axis not parallel to the direction of flow. (5) According to another embodiment, the paddles are concave to the direction of flow. (4)

It is now disclosed for the first time a turbine, called a Benkatina turbine,

comprising:

a. a main chamber,
b. a side chamber,
c. a turbine that directs flow from the main chamber partially into the side chamber and from the side chamber back into the main chamber's stream of flow at a location prior to passage through the turbine. (3) (Of course, part of the flow continues down the main chamber.)

It is now disclosed for the first time a paddle for a turbine paddle wheel, comprising, a. an area of steeper topography (37) and greater depth (34, 40) in the concave orientation to the flow at the periphery of the paddle blade than towards the center. (The objective here is to create an aerodynamic paddle that also maximizes torque.)

In one embodiment, the system further comprises b. a Benkatina turbine, holding said paddles. In one embodiment, the system further comprises c. a convex section (35) of the paddle located between the hub and the deepest section of the paddle. (The objective here also is to direct the flow to the area of greatest torque.) According to another embodiment, the blades possess flexible deeper peripheral regions. (46, 47) According to another embodiment, the blades possess a flexible two-way shape. (47) According to another embodiment, the blades are removable and replaceable into the paddle wheel. (44, 45)

It is now disclosed for the first time a Benkatina turbine system, comprising:

a. a Benkatina turbine, (23)
b. a collecting pipe (21) wider than the main chamber (22).

It is now disclosed for the first time a Benkatina turbine system, comprising:

a. a Benkatina turbine, (30)
b. a diffusing pipe (31) wider than the main chamber (29).
The above two claims of collecting and diffusing pipes refer not just to piping of different diameters, but also to devices that collect or diffuse the flow.

It is now disclosed for the first time a Benkatina turbine system, comprising: at least 1 Benkatina turbine and at least a second turbine. (Although at some points in this patent, specific distances between Benkatina pipes and Benkatina turbines are mentioned, we define the cases where they are not specified as being close enough to each other to be part of a connected system, rather than a series of individual, scattered turbines. One way of recognizing connectedness is removing a majority or a maximum of the energy available for capture at a particular point of the environment. This is somewhat subjective but does make the point that the average turbine in general, with inefficiencies and Betz' Law taken into consideration, will capture less than 50%, in fact closer to 30%, of the energy in a flow, so that capturing the maximum available or more than 50% brings the user into the techniques mentioned in the current invention.) According to another embodiment, the second turbine is a Benkatina turbine. According to another embodiment, each turbine is located within 5 main chamber diameters of the other turbine. According to another embodiment, two adjacent turbines are on the same side of the main chamber. According to another embodiment, two adjacent turbines are not on the same side of the main chamber. According to another embodiment, two adjacent turbines are on the same plane. According to another embodiment, two adjacent turbines are not on the same plane.

It is now disclosed for the first time a turbine, comprising:

a. a means for shifting the torque to the periphery of the blades.
According to another embodiment, said means consist of blades with topographic deepening in the periphery. (This is different from a cup in a turbine, wherein the topographic depth is in the center of the cup. Here the periphery is defined as the 50% distal portion of the blade or less measured from the most proximal to the most distal part of the blade, independent of any holders.)

It is now disclosed for the first time a turbine system, comprising:

a. at least two turbines in a pipe within 5 pipe diameters of each other.

It is now disclosed for the first time a turbine system for capturing fluid flow, comprising:

a. A housing surrounding the turbine energy capture component,
b. A means for at least partial recirculation of the fluid through the turbine. (1-5) (This defines a more general case of recirculation than the Benkatina earlier described.) According to another embodiment, the system is closed. (FIG. 7) According to another embodiment, the fluid is a liquid. According to another embodiment, the fluid is a gas. According to another embodiment, the means is a paddle wheel. According to another embodiment, the means is a side chamber connected to a main chamber and a turbine's energy capture component in the middle.

It is now disclosed for the first time a turbine system, comprising:

a. a main chamber making a circuit of substantially 360 degrees,
b. at least one Benkatina turbine attached to said main chamber. (FIGS. 2, 7, 8, 9)
In one embodiment, the system further comprises c. a central interior axis (13, 57) to the circuit to which each Benkatina turbine side chamber is attached. According to another embodiment, the central axis is capable of rotation and is attached to a generator. In one embodiment, the system further comprises d. an inlet connected to a piston or plunger. According to another embodiment, the system is closed. (“Closed” refers to not allowing entrance or exit of fluid from the whole system when operating.) In one embodiment, the system further comprises e. a movable membrane on at least part of the main chamber. (61, 65) In one embodiment, the system further comprises d. an inlet valve, (53) and e. an outlet valve, (52) which is proportionately to totally closed when the inlet valve is proportionately open, and vice versa. In one embodiment, the system her comprises f. a plunger or piston (48) connected to said inlet. According to another embodiment, the outlet valve returns fluid into the piston chamber.

It is now disclosed for the first time a turbine system, comprising:

a. At least one Benkatina turbine,
b. An inlet (1, 21) and outlet (6, 31) located substantially 180 degrees away from each other.
According to another embodiment, the main chamber is linear. (14) According to another embodiment, the main chamber is not linear. (16) In one embodiment, the system further comprises c. a central support structure (28) around which the turbine system rotates. In one embodiment, the system further comprises d. at least a second 180-degree turbine system connected to said support structure. (25, 26) According to another embodiment, the shape of the piping between the inlet and the outlet is an omega shaped pipe diversion, with a Benkatina turbine attached to the diversion. (FIG. 17) (The purpose of this is to allow energy to be captured with minimal extension of the distance between the inlet and outlet pipes.)

It is now disclosed for the first time a Benkatina turbine system, wherein the main chamber is tilted in the direction of the outlet. (One purpose is to prevent stagnation.)

It is now disclosed for the first time a turbine system, comprising:

a. A pipe,
b. At least 2 turbines within the pipe within a distance of 50 meters or less from each other's proximate edge. (FIG. 3)
According to another embodiment, the distance is 10 meters or less. According to another embodiment, the distance is 5 pipe diameters or less. According to another embodiment, the distance is 4 pipe diameters or less. According to another embodiment, the distance is 3 pipe diameters or less. According to another embodiment, the distance is 2 pipe diameters or less. According to another embodiment, the distance is 1 pipe diameter or less. According to another embodiment, at least one of the turbines is a Benkatina.

It is now disclosed for the first time an instream turbine system, comprising:

a. at least two turbines (107, 111) connected by a main chamber (109),
b. an alternate path of piping exiting (108) between the first and second turbine, said alternate path connected to the main chamber on one end and having an outlet without a turbine. (110) (Turbines have bad diverging piping in the past; the new point here is that this is an instream turbine, such as in a tidal flow, where this divergence has not been used.)

According to another embodiment, at least one turbine is a Benkatina turbine. (107, 111) In one embodiment, the system further comprises c. a means for directing flow. (The directing flow refers to one or the other pipes.) According to another embodiment, said means is located within one main chamber diameter from the junction of the main chamber and the alternate chamber. According to another embodiment, the means is a valve. (108, 109) According to another embodiment, the means is a valve beyond the junction towards the outlet. (108) According to another embodiment, the means is a valve beyond the junction towards the second turbine. (109) According to another embodiment, the means is flow sensitive. According to another embodiment, the means is pressure sensitive. According to another embodiment, said means directs the flow towards the second turbine (109) when the flow speed is above a set amount. According to another embodiment, said means directs the flow towards the outlet (108) when the flow speed is below a set amount. According to another embodiment, said means is mechanical engagement/disengagement. In one embodiment, the system further comprises c. a collector. In one embodiment, the system further comprises c. a diffuser.

It is now disclosed for the first time a turbine system, comprising:

a. at least two turbines in a pipe within 20 main chamber diameters of pipe length from each other's proximate edge,
b. said pipe winds down in a corkscrew configuration. (20)
According to another embodiment, at least one turbine is a Benkatina Turbine. According to another embodiment, both turbines are Benkatina turbines. According to another embodiment, both turbines (that is, their side chambers) are on the inner side of the curve. According to another embodiment, both turbines are on the outer side of the curve. According to another embodiment, both turbines are on alternate sides of the curve.

It is now disclosed for the first time a turbine system, comprising:

a. two Benkatina turbines in sequence in a pipe within 10 chamber diameters of each other's proximate sides, wherein a straight main chamber is next to a straight main chamber (14, 15)

It is now disclosed for the first time a turbine system, comprising:

a. two Benkatina turbines in sequence in a pipe within 10 meters of each other's proximate sides, wherein a curved main chamber is next to a straight main chamber. (17, 18) According to another embodiment, the side chamber is on the inside of the curve. (16) According to another embodiment, the side chamber is on the outside of the curve. (19)

It is now disclosed for the first time a turbine system, comprising:

a. two Benkatina turbines in sequence in a pipe within 10 meters of each other's proximate sides, wherein a curved main chamber is next to a curved main chamber. (16)
According to another embodiment, the side chamber is on the inside of the curve. (16) According to another embodiment, the side chamber is on the outside of the curve. (19)

It is now disclosed for the first time an instream turbine system, comprising:

a. An intake (24),
b. Two pipes dividing from the intake (25, 26), said pipes located around a center (28) before proceeding to the outlet,
c. At least one turbine. FIG. 16)
According to another embodiment, the two pipes rejoin before reaching the outlet. (29) According to another embodiment a turbine is on each division of the intake. (26, 27) According to another embodiment, each turbine is a Benkatina.

It is now disclosed for the first time an instream turbine system, comprising:

a. A Benkatina turbine, (23)
b. A collector. (21)

It is now disclosed for the first time an instream turbine system, comprising:

a. A Benkatina turbine, (23, 30)
b. A diffuser. (31)
In one embodiment, the system further comprises c. a collector.

It is now disclosed for the first time a turbine system, comprising:

a. at least one Benkatina turbine,
b. a vane. (32)
According to another embodiment, said system is underwater. According to another embodiment, said system is not underwater

It is now disclosed for the first time a vane for a turbine, comprising:

a. Four planar tails (148, 149), each separated by approximately 90 degrees. (This enables vertical adjustment to flow as well. Of course, the position of the supporting structure such as a wind tower or pile will limit the vertical adjustment, and a means for avoiding or limiting its impact on the supporting structure should be used.)
According to another embodiment, the turbine is located in a gaseous environment. According to another embodiment, the turbine is located in a liquid environment.

It is now disclosed for the first time a vane for a turbine, comprising:

a. A diffuser (150) at the outlet of said turbine, said diffuser having at least two sections, each section located approximately circumferentially equidistant from each other. (In other words, the diffuser also fulfills the function of a vane in order to direct the turbine.)
According to another embodiment, said diffuser has at least 4 sections.

It is now disclosed for the first time a diffuser for a turbine, wherein said diffuser divides up into at least two elongated parts circumferentially equidistant from each other. (150) (This defines the diffuser as useful for functioning as a vane.)

It is now disclosed for the first time a Benkatina pipe, comprising:

a. a main chamber with a rectangular cross-section, (39)
b. a side chamber forming half of a cylindrical shape.

It is now disclosed for the first time a Benkatina turbine, comprising:

a. a main chamber with a rectangular cross-section,
b. a side chamber forming half of a cylindrical shape, (39)
c. A Benkatina turbine on the inside.
(The above configurations of a cylindrical system are also included in the definition of a Benkatina pipe or turbine.)

It is now disclosed for the first time a turbine system, comprising:

a. a substantially horizontal turbine with a 360 degree turn, (referring to the turn of the system)
b. an inlet from above, (66)
c. a lower outlet. (70)
According to another embodiment, the turbine is a Benkatina.

It is now disclosed for the first time a turbine system, comprising:

a. a vertical stack of at least two substantially horizontal turbines. (72, 74)
According to another embodiment, the turbines are Benkatina turbines.

It is now disclosed for the first time a system for the capture of energy, comprising:

a. a gutter, (86, 90)
b. at least one turbine connected to the gutter, said gutter operative to supply an inlet to the turbine. (86)
According to another embodiment, the turbine is a Benkatina turbine. (88) According to another embodiment, the gutter is a building gutter. (86) According to another embodiment, the gutter is a street gutter. (90) According to another embodiment, the turbine is substantially horizontal in orientation. In one embodiment, the system further comprises c. an angled inlet (87) from the gutter (86) to the turbine (88). In one embodiment, the system further comprises c. a funnel (91) from the gutter (86) to the turbine (88). According to another embodiment, the pipe through the turbine has a descending corkscrew arrangement. (20)

It is now disclosed for the first time a Benkatina turbine, wherein the turbine is used in an environment of gas flow.

It is now disclosed for the first time a Benkatina turbine, wherein the turbine is used as part of a dam.

It is now disclosed for the first time a Benkatina turbine, wherein the turbine is used for underwater flow in a body of fresh water.

It is now disclosed for the first time a Benkatina turbine, wherein the turbine is used for underwater flow in a body of salt water.

It is now disclosed for the first time a Benkatina turbine, wherein the turbine is used in a pipe.

It is now disclosed for the first time a Benkatina turbine, wherein the turbine is used in a system for hydroelectric storage.

It is now disclosed for the first time a hydroelectric storage system, comprising:

a. A support structure, (75)
b. At least an upper and a lower tank operative to contain at least one kind of fluid, (76)
c. A pump system from the lower tank to the upper tank, (80, 81)
d. A turbine system, comprising a gated pipe (116) and a turbine, from the upper to the lower tank. (78, 118) (This is an artificial hydroelectric storage system. The word “tank” excludes a dam. Dams already exist as hydroelectric storage systems.)
According to another embodiment, the turbine is a Benkatina turbine. According to another embodiment, the pipe material is partially flexible. (117) In one embodiment, the system further comprises e. an electronic sensor and controller connected to the tank, the turbine, and the pump. (82, 83, 84) According to another embodiment, the inlet (143) and outlet (144) are capable of vertical movement. According to another embodiment, the inlet and outlet are connected in one piece (142), with the inlet superior to the outlet. In one embodiment, the system further comprises f. a guide (115, 147) for vertical movement of the inlet and outlet. In one embodiment, the system further comprises f. a flotation device (146) attached to the inlet and/or the outlet, said flotation device operative to maintain the outlet just below the surface (145) and the inlet just above the surface.

It is now disclosed for the first time a turbine system for extracting energy, comprising:

a. an inlet means, (53)
b. an outlet means (52) substantially adjacent to said inlet means,
c. a substantially tubular housing, interiorly hollow, the outer circumference of said housing connecting the inlet and outlet means after a circumference of nearly 360 degrees, (35)
In one embodiment, the system Her comprises d. at least one turbine in the center of the tubular housing. (56, 57) In one embodiment, the system further comprises e. at least one of said turbines is a Benkatina turbine. In one embodiment, the system further comprises f. a mechanical energy input means (48, 49, 50) connected to the inlet into the tube. According to another embodiment, said inlet (60) is distal to the outlet (59) from the tube and the contents pass nearly 360 degrees through the system from inlet to outlet and are available for reuse as the outlet directs the contents into the passage (51) of the mechanical energy input (50). According to another embodiment, the mechanical energy means is a plunger. In one embodiment, the system further comprises g. a spring, operative to push back the mechanical energy input means. According to another embodiment, the said mechanical energy means is a piston.

It is now disclosed for the first time a turbine system for extracting energy from a fluid, comprising:

a. a housing, (8) defining the limits of a main chamber (9a) for fluid flow,
b. a first circular rotating energy capture device,
c. a first generator attached to said first circular device, (13)
d. a second generator, (10)
e. a second energy capture device attached to the second generator and attached substantially near to the outer circumferential edge of the first circular device and operative partially outside the radius of said first circular device.

It is now disclosed for the first time a turbine system for the capture of energy, comprising:

a. A device for applying mechanical energy to a fluid in a container, (48)
b. At least two turbines within said system that capture energy from two substantially separate rotational axes simultaneously. (10, 13)
According to another embodiment, the application device is a plunger. (48) In one embodiment, the system further comprises c. a flexible membrane (61, 65) on the interior surface of the container, said membrane contacting the fluid contents. According to another embodiment, the contents circulate in one direction through at least one one-way device. (59, 60, 63, 64) According to another embodiment, said contents recirculate through the outlet into the passageway of the inlet. (59, 60)

It is now disclosed for the first time a system for the capture of energy, comprising:

a. an energy capture device in one axis of rotation, (10)
b. a second energy capture device in a separate axis of rotation, (13)
c. a connection between the first and second devices that translates motion from the first device to the second. (12)

It is now disclosed for the first time a turbine system comprising:

a. a pipe comprising a turbine,
b. a side chamber operative to recirculate at least some of the fluid that has passed through the turbine back to the space in the pipe prior to the turbine.

It is now disclosed for the first time a method of varying the cut-in speed of a turbine, comprising:

a. Engaging and disengaging passageways for the fluid.

It is now disclosed for the first time a method of varying the cut-in speed of a turbine, comprising:

a. diverting and blocking passageways for the fluid.

It is now disclosed for the first time a turbine system, comprising:

a. at least one Benkatina turbine
b. a two-way generator
In one embodiment the system further comprises c. paddles for the Benkatina turbine with a rigid frame (46) and interior flexible material. (47) (The flexible material can, in one embodiment, be shaped so that it assumes a streamlined shape in flow from either direction.)

It is now disclosed for the first time a paddle for a Benkatina turbine, wherein the peripheral part of the paddle is congruent to the outer circle of the side chamber. (33)

It is now disclosed for the first time a method of manufacturing a vane for an enclosed turbine, wherein the exhaust from the turbine also serves as the vane. (150)

It is now disclosed for the first time a device for hydroelectric storage in a dam, comprising:

a. an inlet for bringing in fluid,
b. an outlet for exit to a turbine,
c. a means for adjusting height of the inlet and/or the outlet, said means operative to maintain the outlet just below the surface and the inlet just above the surface.
In one embodiment, the system further comprises d. a flotation device attached to the inlet and/or the outlet, said flotation device operative to maintain the outlet just below the surface and the inlet just above the surface. According to another embodiment, the inlet and outlet are connected in one piece.

1-174. (canceled)

175. A pipe (defined as a non-portable enclosure operative to convey a fluid from one location to another), called a Benkatina pipe, for a fluid, comprising:
a. A main chamber, comprising the main flow of the fluid,
b. A substantially semicircular, side chamber in communication with the main chamber along at least part of the area between two straight lines of the main chamber wall, wherein said side chamber has an axis not substantially parallel to the direction of main chamber flow,
c. a system of turbine blades within said chambers that does not consist of a vaned disc.

176. A pipe (defined as a non-portable enclosure operative to convey a fluid from one location to another), called a Benkatina pipe, for a fluid, comprising:
a. A main chamber, comprising the main flow of the fluid,
b. A substantially semicircular, side chamber in communication with the main chamber along at least part of the area between two straight lines of the main chamber wall, wherein said side chamber has an axis not substantially parallel to the direction of main chamber flow, wherein said side chamber's central axis point is located along the imaginary continuation of two lines along the length of the wall of the main chamber.

177. A pipe (defined as a non-portable enclosure operative to convey a fluid from one location to another), called a Benkatina pipe, for a fluid, comprising:
a. A main chamber, comprising the main flow of the fluid,
b. A substantially semicircular, side chamber in communication with the main chamber along at least part of the area between two straight lines of the main chamber wall, wherein said side chamber has an axis not substantially parallel to the direction of main chamber flow, wherein said side chamber's central axis point is located along the imaginary continuation of one line along the length of the wall of the main chamber.

178. A piping system, comprising:
a. two substantially semicircular side chambers, originating from the main chamber or its continuation within 5 main chamber diameters of the end of the first side chamber.

179. Sew) A piping system, comprising:
a. A main chamber, comprising the main flow of the fluid,
b. A substantially semicircular, side chamber in communication with the main chamber along at least part of the area between two straight lines of the main chamber wall, wherein said side chamber has an axis not substantially parallel to the direction of main chamber flow, wherein the main chamber cross-section is substantially rectangular in a plane perpendicular to the direction of flow and the side chamber is substantially a partial cylinder.

180. A Benkatina turbine, comprising:
a. a Benkatina pipe,
b. a turbine placed in said pipe that moves in both the main and side chambers.

181. A paddle for a Benkatina turbine, comprising:
a. an area of steeper topography and greater depth in the concave orientation to the flow at the near-periphery of the paddle blade than in the center, said greater depth substantially existing in the outer half of the blade.
b. a convex section of the paddle located in the central section of the paddle.

182. A Benkatina turbine system, comprising:
a. a Benkatina turbine,
b. a flanged pipe wider than and attached to the main chamber.

183. An in-stream turbine system, comprising:
a. at least two turbines connected by a main chamber,
b. an alternate path of piping exiting between the first and second turbine, said alternate path connected to the main chamber on one end and having an outlet without a turbine on the other.

184. An in-stream turbine system, comprising:
a. An intake,
b. Two pipes dividing from the intake, said pipes located around a central supporting structure before proceeding to the outlet,
c. At least one turbine.

185. A vane for a turbine, comprising:
a. at least four substantially planar tails, substantially circumferentially equidistant.

186. A vane for a turbine system, comprising:
a. A diffuser at the outlet of said turbine system, said diffuser having at least two radial sections, each section located approximately circumferentially equidistant from each other.

187. The vane of claim 186, wherein said diffuser has at least 4 substantially circumferentially equidistant sections.

188. A turbine system, comprising:
a. a main chamber with a substantially 360 degree turn with a non-horizontal axis,
b. an upper inlet,
c. a lower outlet,
d. at least one turbine connected to the main chamber.

189. A system for the capture of energy, comprising:
a. a gutter,
b. at least one turbine connected to the gutter, said gutter operative to be an intake to the turbine.

190. A hydroelectric storage system, wherein a section of the pipe material used in flow to or from the storage structure is flexible.

191. A hydroelectric storage system, wherein at least one of the inlet and outlet is capable of vertical movement.

192. A hydroelectric storage system, comprising:
a. a flotation device attached to the inlet and/or the outlet, said flotation device operative to maintain the outlet just below the surface or the inlet just above the surface.

193. A turbine system for the capture of energy, comprising:
a. A device for applying linear force to a fluid in a container,
b. At least two turbines communicating with said container that capture energy from two separate rotational axes simultaneously.

194. A system for the capture of energy, comprising:
a. an energy capture device in one axis of rotation,
b. A second energy capture device in a separate axis of rotation,
c. A connection between the first and second devices that translates motion from the first device to the second.

195. A method of varying the cut-in speed of a turbine, comprising:
a. opening and blocking passageways for the fluid.

196. A turbine system, comprising:
a. a Benkatina turbine
b. a two-way generating means attached to said Benkatina turbine.

197. A method of manufacturing a vane for a turbine, wherein the exhaust structure of the turbine also serves as the vane.
